(19) United States
(12) Patent Application Publication
(10) Pub. No.: US 2006/0034445 A1
(43) Pub. Date: Feb. 16, 2006

(54) Method and system for prioritising incoming communications

(75) Inventor: Richard Henry Shelton, Hillmorton (NZ)

Correspondence Address: NIXON & VANDERHYE P.C., 8th Floor, 1100 North Glebe Road, Arlington, VA, 22201, US

(73) Assignee: Zanick Enterprises Limited, Hillmorton (NZ)

(21) Appl. No.: 11/117,725

(22) Filed: Apr. 29, 2005

(30) Foreign Application Priority Data
Aug. 13, 2004 (NZ) 525951

(51) Int. Cl. H04M 3/00; H04M 5/00

(52) U.S. Cl. 379/266.01

(57) ABSTRACT

The present invention relates to a system and method for the automatic prioritising and queuing of incoming communications. More particularly, although not exclusively, the present invention relates to a system and method that ensures that the next incoming telephone call, waiting in the queue to be answered, will have the highest priority and hence highest value to the recipient. The invention also includes software and apparatus for the automatic prioritising and queuing of incoming communications.

### FIELD OF INVENTION

The present invention relates to a system and method for the automatic prioritising and queuing of incoming communications.

More particularly, although not exclusively, the present invention relates to a system and method that ensures that the next incoming telephone call, waiting in the queue to be answered, will have the highest priority and hence highest value to the recipient.

### BACKGROUND OF THE INVENTION

Many businesses rely on their telephone communication system to enable customers to make contact with them. An easily recognised and remembered telephone number is a valuable asset. Many businesses seek to differentiate themselves by their telephone number and spend considerable money on advertising campaigns emphasising their unique telephone number.

The number of telephone calls a business can receive is limited by the number of telephone lines from the telecommunication provider to the business' internal telephone system. In order for a caller to make contact with the business, one of these telephone lines must be unused at the time the call is made. Once the number of callers matches the number of telephone lines all telephone lines become busy and no further incoming calls can be received. If additional calls are made once all available lines are busy the caller will receive a busy signal and will not be able to make contact with the business. This situation is commonly experienced by many businesses, particularly during busy periods for that business. For example, it is not uncommon during periods, such as weekends and public holidays, for thousands of calls per hour to a Taxi Service Provider to be unable to make contact with the Service Provider.

It is therefore inevitable that some callers will not be able to make contact with a business and may, as a result, contact a business competitor. Some of the telephone calls received by a business are more valuable to the business than other calls. For example, calls from particular people or companies may be highly valued. Furthermore, calls from regular callers may be more highly valued by the business than calls from occasional callers. During busy periods a highly valued or regular caller will expect to be able to make contact with the business because of the previous history of regular patronage. A business will also prefer to receive those calls that are highly valued than those calls of less value. However, due to the nature of the communication system, calls are received by the business on a “first come—first served” basis. A regular caller cannot ensure they will be able to connect to the business, and the business cannot ensure the calls they are receiving are the most highly valued calls.

Until now there has not been a satisfactory method of differentiating between a highly valued incoming telephone call and a less valued incoming telephone call and ensuring that the available telephone lines are used by preferentially highly valued incoming telephone calls.

One solution has been the dissemination of a confidential telephone number, different from the general telephone number for a business, to regular and highly valued callers. However, the telephone number is eventually widely disseminated and it becomes increasingly difficult for these callers to make contact with the business as the line they are trying to connect to becomes busier.

Another solution has been to increase the internal infrastructure of the business' telephone system by increasing the number of telephone lines from the telecommunication provider to the business' internal telephone system. As the number of incoming telephone lines increases so does the number of successful connections. However, there is still no guarantee that a highly valued call is going to secure an available line before another call.

Yet another solution has been the introduction of the Interactive Voice Response system which aims to reduce the time taken for the business to service a call, and therefore reduce the time between receipt of a call and the telephone line becoming available to take another call. However, this system does not guarantee that a highly valued call is going to secure an available line. Furthermore, where the caller is calling to request resources, such as a taxi, the Interactive Voice Response system does not guarantee that a highly valued customer will be sent a taxi before another customer.

Digital telephone systems are known which have an Automatic Call Distribution feature. This feature uses a caller identification function to sort incoming calls into a limited number of groups, commonly between two and twenty. Incoming calls allocated to the same group are queued within that group in the order of their arrival at the business' internal telephone system. The groups may then be prioritised so that all incoming calls in one group are answered before the incoming calls in another group.

Such a system ensures that calls in a group with the highest priority are answered before calls in a group with a lower priority. However, it does not prioritise all incoming telephone calls relative to all other incoming calls. This system provides only a limited ability to prioritise calls as there are only a limited number of groups into which an incoming call can be placed. Furthermore, calls in the same group cannot be prioritised relative to each other. Also, this system does not overcome the problem of highly valued calls receiving a busy signal once all telephone lines into the business telephone system are in use by other callers.

Another known feature of digital telephone systems is the option for an operator of the system to allocate a priority number to an incoming call before having it placed into a group as above.

This feature requires manual interaction with the call before it is placed into a queue. It also does not disclose allocation of a priority number based on the caller identification function.

U.S. Pat. No. 5,930,700 discloses a system wherein a user stores in a database the relative priority of calls based on their origin (caller identification), and also stores in a schedule the location of the user at various times of the day (the call delivery address). The user also sets a priority threshold which is used to determine which calls are of a high priority and which are of a low priority. When an incoming call is received, the system determines its priority in relation to the priority threshold. If the call is of a high priority it is delivered to the user at the call delivery address, and if the call is of a low priority it is directed as specified by the user, for example to a message service or to another person.

U.S. Pat. No. 4,429,188 discloses a system wherein a two digit code is disseminated to some callers, who then use the code when making their call to allow the system to discriminate between desired and undesired incoming calls.

The above two systems are not directed to the situation of multiple incoming telephone lines and the need for highly valued calls to secure an incoming line. Furthermore, they do not disclose the prioritisation and queuing of calls relative to all other calls.

It is the object of the present invention to provide a system and method for prioritising and queuing incoming communications to ensure that the next incoming communication answered has the highest value to the user of the system, which overcomes the disadvantages of the prior art, or at least provides a useful alternative.

### SUMMARY OF THE INVENTION

According to a first aspect of the invention there is provided a system for prioritising incoming communications wherein the origin some of the incoming communications are identified by an origin identifier and wherein for a set of origin identifiers each origin identifier is associated with a fixed priority indicator and each priority indicator is unique within said set and wherein each incoming communication is placed in an ordered queue on the basis of its associated priority indicator.

Preferably at least one of the fixed priority indicators is set by a user of the system and is permanent. It is also preferable that at least some of the origin identifiers are not members of said set and these origin identifiers are associated with a dynamic priority indicator. In a preferred embodiment all of the priority indicators can be unique. The priority indicators are representative of the degree to which the origin identifier, with which the priority indicator is associated, meets criteria. These criteria may relate to the economic value of a communication from the identified origin, the number of communications from the origin identified by the origin identifier, or the time of the communication.

Preferably the system has at least one channel by which incoming communications can be received which is reserved for the receipt of an incoming communication, calculation of the priority indicator, and queuing of the incoming communication.

According to a further aspect of the invention there is provided a method of associating a dynamic priority indicator to an origin identifier of an incoming communication including the steps of identifying the origin identifier of the incoming communication, prioritising the incoming communication, calculating a priority indicator for the origin identifier, and recording the priority indicator.

The origin identifier may be associated with a pre-existing priority indicator. Preferably the calculation of the priority indicator for the origin identifier occurs with out manual intervention, and includes the use of a pre-existing priority indicator associated with the origin identifier, and may include associating the origin identifier with a default priority indicator. Calculation of the priority indicator for the origin identifier may also include reference to the number of incoming communications with a related origin identifier during a period of time and/or to each historic priority indicator associated with the origin identifier during a period of time. This period of time may be specified by a user.

Preferably no reference is made to incoming communications received earlier than the start of the period of time.

According to a further aspect of the invention there is provided a method of prioritising incoming communications associated with an origin identifier, including the steps of determining a priority indicator of the origin identifier of an incoming communication, and inserting the incoming communication into an ordered queue containing other incoming communications with associated priority identifiers wherein the queue is ordered on the basis of the priority indicators, and wherein for a set of the origin identifiers each origin identifier is associated with a fixed priority indicator and each priority indicator is unique within said set.

According to a further aspect of the invention there is provided an apparatus for prioritising incoming communications associated with origin identifiers, including a processor arranged for receiving notification of an incoming communication, retrieving an origin identifier associated with the incoming communication from a memory, retrieving a priority indicator associated with the origin identifier from a memory, placing the incoming communication into an ordered queue containing other incoming communications with associated priority identifiers on the basis of the priority indicator, and identifying the communication at the top of the queue for further processing, and a memory arranged for storing origin identifiers and priority indicators; wherein for a set of the origin identifiers each origin identifier is associated with a fixed priority indicator and each priority indicator is unique within said set.

Preferably the memory is further arranged for storing a name associated with the origin identifier or a reason for the association of the priority indicator with the origin identifier, or other information associated with the origin identifier.

According to a further aspect of the invention there is provided computer executable instructions arranged for prioritising incoming communications associated with an origin identifier.

According to a further aspect of the invention there is provided computer software for prioritising incoming communications, including a module arranged for receiving notification of an incoming communication, retrieving an origin identifier associated with the incoming communication from a database, retrieving a priority indicator associated with the origin identifier from a database, placing the incoming communication into an ordered queue containing other incoming communications with associated priority identifiers on the basis of the priority indicator, and identifying the communication at the top of the queue for further processing, and a database arranged for storing origin identifiers and priority indicators; wherein for a set of the origin identifiers each origin identifier is associated with a fixed priority indicator and each priority indicator is unique within said set.

Preferably the computer software is stored on storage media arranged for storing the software.

A final aspect of the invention provides for electronic signals resulting from execution of the software and operation of the apparatus.

### BRIEF DESCRIPTION OF THE DRAWINGS

Embodiments of the invention will now be described, by way of example only, with reference to the accompanying drawings in which:

FIG. 1 shows an example of the allocation of fixed priority indicators.

FIG. 2 shows an example of the allocation of dynamic priority indicators.

FIG. 3 shows an example of the allocation of dynamic priority indicators using various criteria set by the user of the system.

FIG. 4 shows an example of the allocation of dynamic priority indicators using a fixed time period of 100 days.

FIG. 5 shows a flow diagram of the prioritization and queuing of incoming communications.

FIG. 6 shows the treatment of incoming communications and operation of the queue.

### DETAILED DESCRIPTION OF PREFERRED EMBODIMENTS

The invention will be described with reference to incoming telephone calls, and particularly in relation to incoming telephone calls to a Taxi Service Provider. However, this is not to be construed as limiting the invention which can relate to other types of incoming communications in other applications. The invention will be known as the Client Priority Queuing (CPQ) System.

The CPQ system is intended to be used by a user who expects to receive considerable quantities of incoming communications from a variety of origins, for example, a Taxi Service Provider who expects to receive many requests for a taxi booking from a variety of people or businesses. The user may have the ability to receive more than one incoming communication simultaneously, however the number of communications that can be received simultaneously is limited. For example, a business which has more than one incoming telephone line, but the number of incoming telephone lines is limited. The CPQ system is intended to be used where the number of incoming communications which the user expects to receive exceeds the capacity of the user to service such communications. For example, the number of requests for taxi bookings received by a Taxi Service Provider exceeds the number of operators available to service requests. Some of the telephone calls received by the user will be more valuable to the business than other calls. The CPQ system provides a method to ensure that the user of the system receives calls in order from those which the user considers to be of the highest value to those which are of the lowest value to the user.

Introduction of Terminology

In the CPQ system, incoming communications may be identified by an origin identifier. The origin identifier identifies the origin of the communication. For example, an incoming telephone call has as an origin identifier the phone number of the caller (as determined by the caller identification function of the telecommunication system). The CPQ system associates a priority indicator with the origin identifier of each incoming communication received by the user of the system.

Description of Priority Indicators

The priority indicator of an origin identifier can be one of two types, fixed or dynamic. A fixed priority indicator is one that the user of the system associates with an origin identifier. The priority indicator is fixed in the respect that it remains constant across several incoming communications from the associated origin identifier. It may also be permanent in the respect that it cannot be changed by the user of the system once it has been set.

A dynamic priority indicator is one that may change each time an incoming communication is received from a particular origin. The priority indicator is initially set by the system according to the criteria specified by the user of the system. When each subsequent call is received from the same origin the system calculates a new priority indicator to associate with the origin identifier of the incoming communication.

The priority indicator may be any combination of numbers, letters or symbols. It is representative of the degree to which the origin identified by the origin identifier meets criteria set by the user of the system.

The number of possible priority indicators that are available to be associated with an origin identifier is at most equivalent to the number of unique origin identifiers known to the system. In a preferred embodiment all priority indicators are unique. Therefore, each origin identifier is associated with a unique priority indicator. This preferred embodiment is advantageous as it allows every call to be ranked in relation to the priority of every other call thereby avoiding the disadvantage of having many calls having the same priority indicator.

In a preferred embodiment, a user of the system may specify the criteria by which priority indicators are calculated and associated with origin identifiers. Such criteria may include the day, time and frequency of communications made to the user, revenue generated as a result of the communication, the economic value of the communication, or geographical location of the originator of the communication. Once the user of the system has specified the criteria for calculating the priority indicators of origin identifiers, the system will store the priority indicator for each origin identifier and may re-calculate the priority indicator each time a call is received from an origin identified by an origin identifier, without any further manual input from the user of the system.

The user may also specify some individual origin identifiers known to the user which are highly valued by the user of the system, either because they meet the criteria described above, or for other reasons, and therefore the priority indicator associated with these origin identifiers reflects this high value. In a preferred embodiment these origin identifiers will be associated with fixed priority identifiers.

Allocation of Fixed Priority Indicators

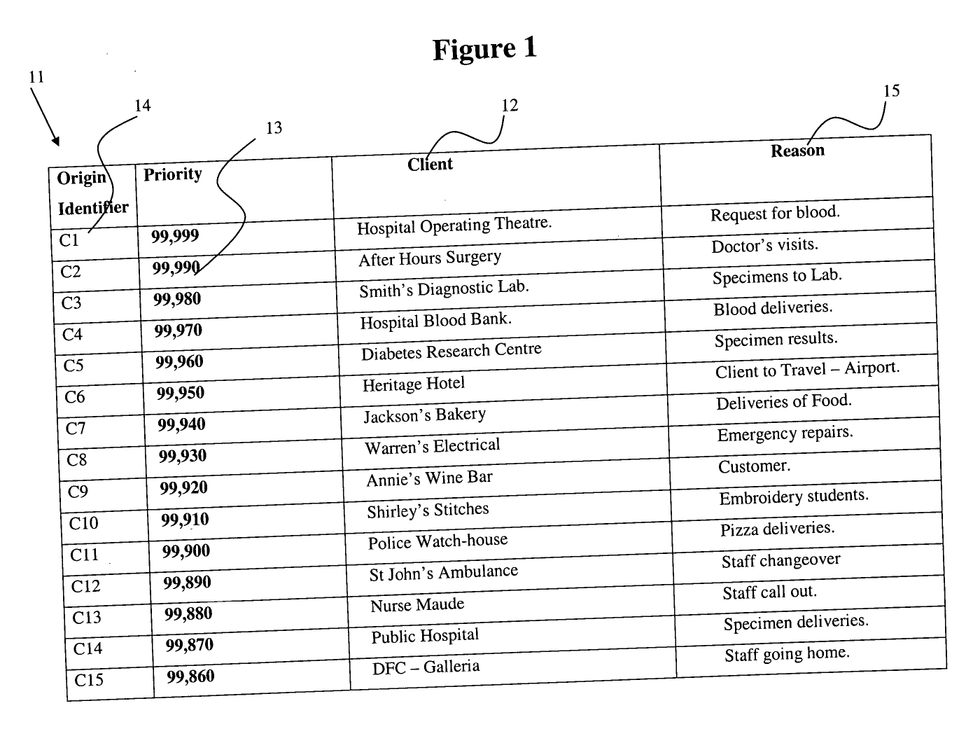

FIG. 1 shows an example 11 of the association of fixed priority indicators with origin identifiers for a Taxi Service Provider. The Taxi Service Provider is able to select those callers 12 to which it wishes to allocate a fixed priority indicator. In a preferred embodiment, the callers whose origin identifier (caller identification number) is associated with a fixed priority indicator will be the most highly valued customers of the Taxi Service Provider, and the associated fixed priority indicator will indicate a higher priority than the dynamic priority indicators associated with other origin identifiers.

In the example shown in FIG. 1 the priority indicators 13 are numbers and a higher number represents a higher priority. The Taxi Service Provider has selected their fifteen most valued callers and has allocated to each a fixed priority number. In a preferred embodiment all fixed priority indicators 13 are unique. While the origin identifiers which have a fixed priority identifier associated with them are all highly valued by the user of the system, it is advantageous to be able to differentiate between these highly valued origin identifiers and be able to prioritise each origin identifier relative to the others. In a preferred embodiment, the fixed priority indicators allocated to origin identifiers 14 are not consecutive, thereby allowing the addition of other origin identifiers and priority indicators at a later time. It is also preferred that the user of the system specifies a reason 15 for the allocation of the particular priority indicator 13 to the origin identifier 14.

Allocation of Dynamic Priority Indicators

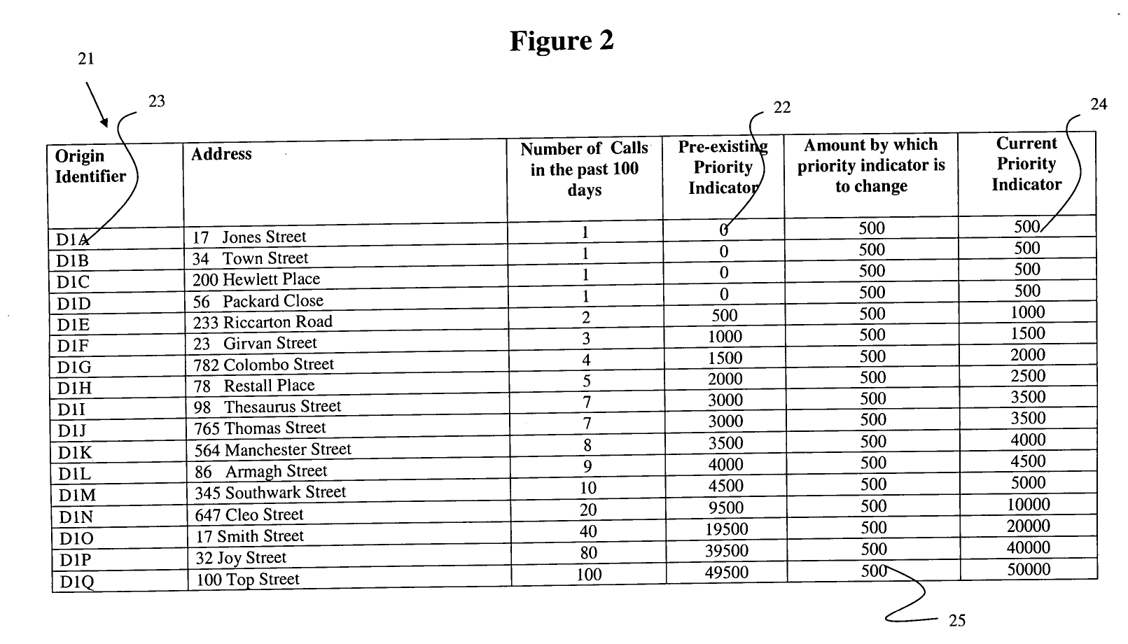

FIG. 2 shows an example of the association of dynamic priority indicators with origin identifiers. This example 21 shows the association of dynamic priority numbers for a Taxi Service Provider user of the system.

The first time that a call is received by the Taxi Service Provider, the system will recognise that a call from the origin identifier (number of the caller) has not previously been received by the system, or does not have a pre-existing priority indicator 22. In one embodiment the system may associate the origin identifier 23 of the call with a default priority indicator 24, in this case, 500. The default priority indicator could be any priority indicator specified by the user of the system. Once a priority indicator is associated with the origin identifier a record is made of the origin identifier and associated priority indicator.

As the priority indicator is dynamic, it may be re-calculated each time subsequent calls are received from the same origin. The second time that a call is received from the same origin the system will recognise that there is a pre-existing priority indicator associated with the origin identifier. Using the criteria set by the user of the system, and the pre-existing priority indicator, the system may re-calculate the priority indicator. In one embodiment the criteria of the user of the system may be the number of communications with the same origin identifier. In this embodiment the user may have set a specific value 25 by which the priority indicator of an origin identifier is adjusted with each subsequent phone call. FIG. 2 shows that with each subsequent phone call, the priority indicator is increased by 500 points. Therefore, with each subsequent phone call, the priority level of the origin identifier becomes higher. A record is made of the origin identifier and the updated priority indicator. A record is also made of the pre-existing priority indicator previously associated with the origin indicator. This becomes a historic priority indicator.

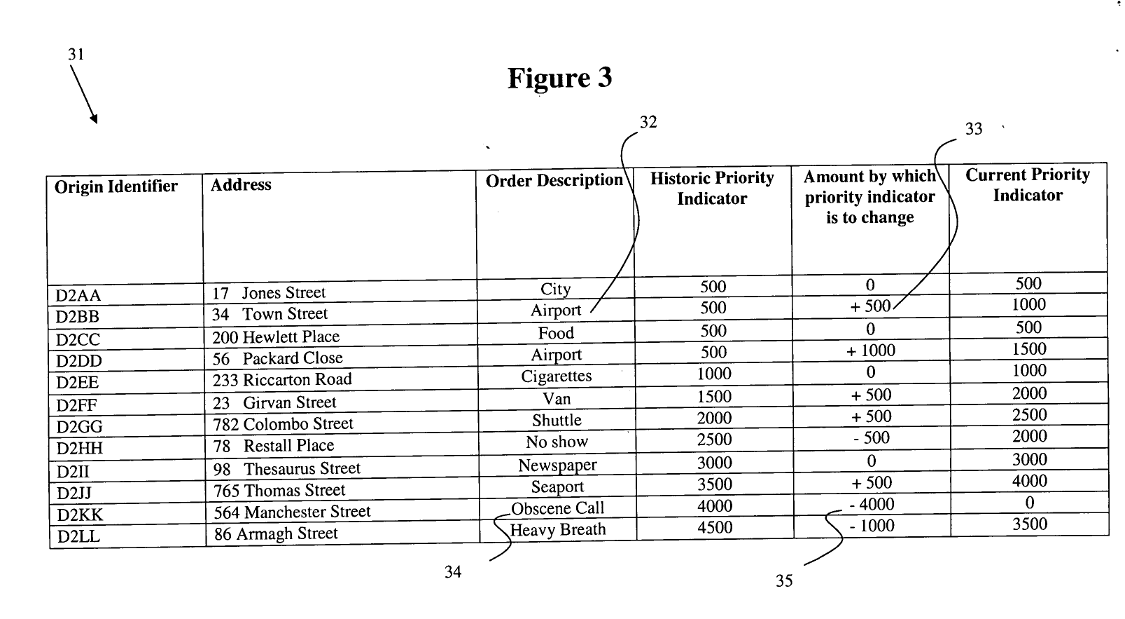

As shown in FIG. 3 the priority indicator may be adjusted based on criteria, such as the nature of the order made in the communication. For example, in a system is used by a Taxi Service provider, where a caller orders a taxi to the airport 32, their priority indicator may be calculated by adding a specified number of points 33 which reflect to what extent the order of a taxi to the airport is valued by the taxi service provider. Another example is a caller who makes an obscene call 34. When the priority indicator for the origin identifier of this call is calculated, the priority of the origin identifier may be reduced 35 as the origin does not meet the criteria set by the system user. Requests for certain vehicles e.g. van, shuttle, bus or limousine may result in increased the priority indicator for an origin identifier as these orders are highly valued by the taxi service provider. However calls such as heavy breathing or obscene or abusive calls may result in a reduction of the priority indicator as these calls are highly disliked by the taxi service provider.

Once the user of the system has specified the criteria by which the priority indicator of each origin identifier is to be calculated, the calculation of the priority indicator can be done by the system without any manual input.

100 Day Cycle for Dynamic Priority Indicators

As shown in FIGS. 2 and 3, the dynamic priority indicator of an origin identifier may be calculated each time a communication is received from the origin identified by the origin identifier. In a preferred embodiment the dynamic priority indicator is calculated with respect only to the history of communications from the origin identifier within a fixed period of time, as specified by the user of the system.

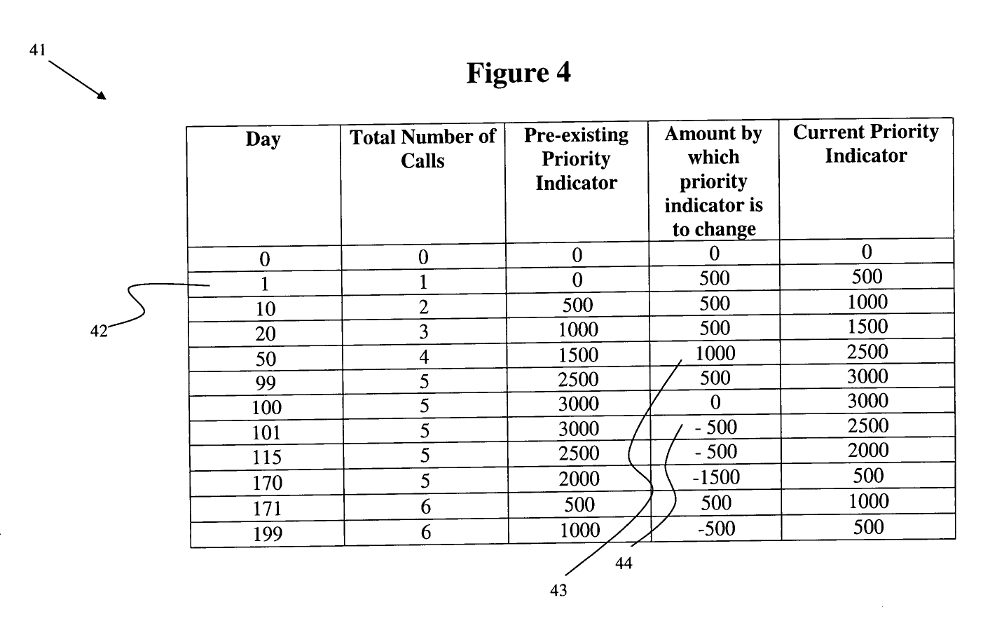

FIG. 4 shows an example of a system where the dynamic priority indicator is calculated with respect only to historic communications which have occurred with in the past 100 days. However, the system is not limited to using a 100 day period. It is contemplated that any period, ranging from minutes to years could be used by the system. As shown in FIG. 2, each time a communication is received, the priority indicator for the origin identifier of the incoming communication is increased by 500. FIG. 4 shows the history of communications and the associated historic priority indicators for communications from one origin identifier in a task 41. On day zero, no calls have been received by the Taxi Service Provider from the origin identifier, therefore, the origin identifier has a priority indicator of zero. On day one a call is made from the origin identifier and the priority indicator of the origin identifier is increased 42. Further calls are made on days ten and twenty. On day fifty a call is made and an order is made for a taxi to the airport, therefore, the priority indicator increases by 1000 43. On day ninety-nine a further call is made, and the priority indicator is now 3000. On day 100, no further calls are made, therefore, the priority indicator remains unchanged. No further calls are made until day 171, therefore, the priority indicator will not increase until day 171. In this example, the system is working on a 100 day time period and day 101 is 100 days since the first call was made. Therefore, the change made to the priority indicator on day one is reversed on day 101, 44, and the priority indicator is reduced by 500 from 3000 to 2500. On day 110, 100 days has passed since the call made on day ten, therefore, the priority indicator is reduced by 500. No changes are made to the priority indicator other than these reductions. Therefore, at day 115 the priority indicator is 3000 (the priority indicator of day 100) reduced by 500 (the change made to the priority indicator on day one), reduced by a further 500 (the change made to the priority indicator on day ten). On day 170, all changes made to the priority indicator earlier than day 70 have been reversed. The priority indicator reflects only those calls made after day 70, in this case, the call made on day 99. The call made on day 99 changed the priority indicator by 500, therefore, the priority indicator on day 170 is 500. As shown, at day 171, another call is made and the priority indicator is increased. However, as shown at day 199, the change made to the priority indicator at day 99 is reversed.

This aspect of the system is advantageous as the priority indicator provides a more accurate reflection of the value of the communication to the business.

Description of Operation of System

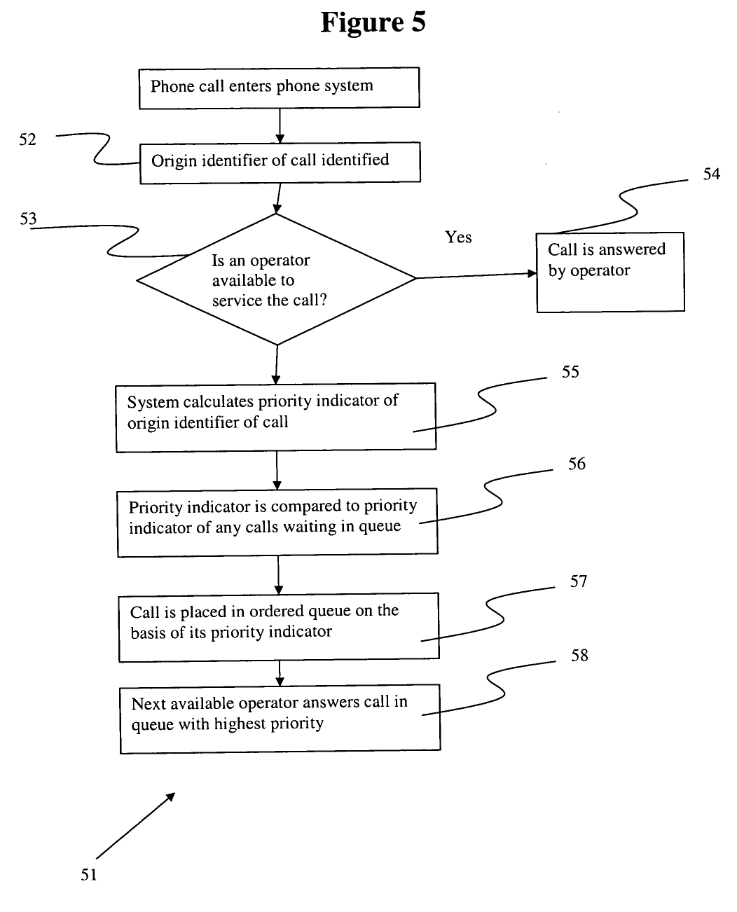

FIG. 5 shows an example 51 of how calls will be treated by a taxi service provider using the CPQ system. When a call enters the Taxi Service Provider's telephone system the origin identifier of the call is identified 52. If an operator is available to answer the call 53, the call will be answered 54. If no operator is available, the CPO system will calculate the priority indicator of the origin identifier of the incoming call 55. This calculation may involve a comparison of the origin identifier of the call with the origin identifiers recorded in the system to determine whether there is a priority indicator associated with the origin identifier. This calculation may also involve associating a priority indicator with the origin identifier. The priority indicator will be compared with the priority indicator of any calls waiting in the queue to be answered 56. On the basis of the priority indicator, and the comparison of the previous step, the call will be placed in the ordered queue 57. When an operator next becomes available to take a call, it will take the call from the queue with the highest priority 58.

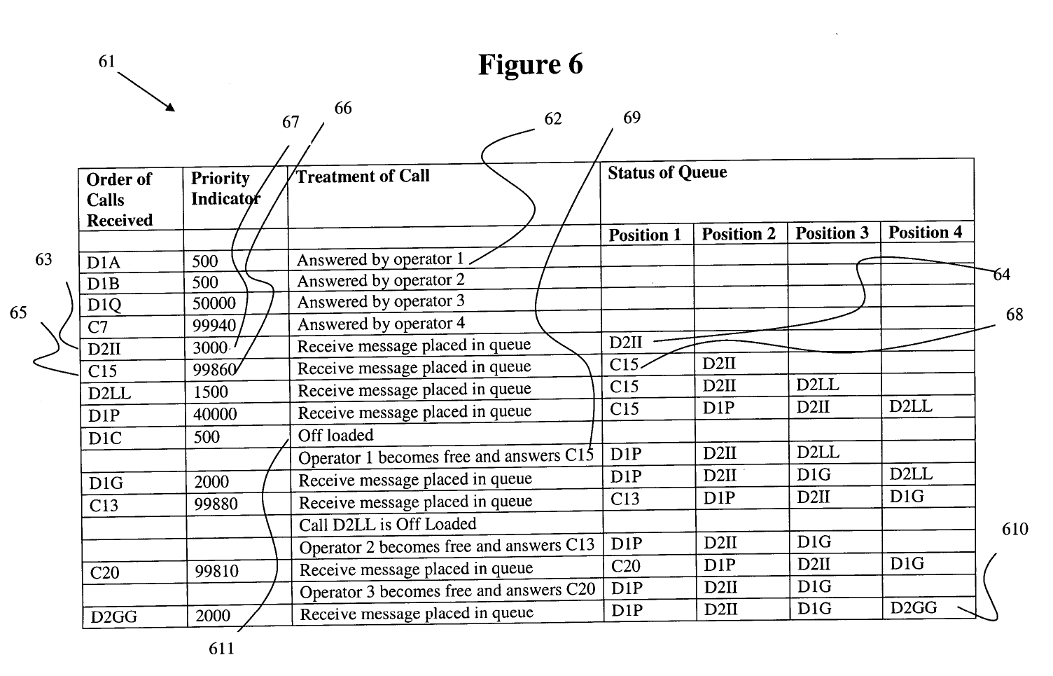

FIG. 6 shows an example of the operation of the ordered queue in the system. For the purposes of the example shown in FIG. 6 the Taxi Service Provider has available eight incoming telephone lines from the telecommunication provider to the Taxi Service Provider's internal telephone system. Therefore, at any one time, a maximum of eight callers can be in contact with the Taxi Service Provider. Furthermore, in the example, there are four operators available to service the incoming calls. As with the previous figures, the priority indicator is a number and a higher number represents that the incoming call is more highly valued by the taxi service provider and is of a higher priority.

As shown in FIG. 6, the first four calls made to the taxi service provider will be answered and serviced by operators 62. The fifth call made to the taxi service provider 63 will be able to make contact with the taxi service provider but will not be able to have their call serviced by an operator until an operator becomes available. This incoming call may have the priority indicator of the origin identifier of the call calculated and will be placed by the system into an ordered queue of waiting incoming calls. As this is the only call presently in the queue, it is at the head of the queue 64 and, therefore, will be the next call serviced when an operator becomes available. In a preferred embodiment, the caller will be given a recorded message telling them that there are presently no operators available to take their call and their call has been placed in a queue to wait for service. A sixth call is now received by the taxi service provider 65. This call is also able to make contact with the service provider, as there are eight lines from the telecommunication service provider's exchange to the taxi service provider's phone system. However, once again there is no operator available to take their call. The priority indicator of the origin identifier of the call will be calculated. This priority indicator will be compared with the priority indicator of the fifth call received which is the only other call in the queue. As the priority indicator of the sixth call 66 is higher than that of the fifth call 67, the sixth call is placed in the ordered queue ahead of the fifth call 68 such that when an operator becomes available the first call that will be answered from the queue will be the sixth call. This call was not the first call received yet it has been promoted to the top of the queue and is answered first when the Taxi Dispatcher became available 69. Where two calls waiting in the queue have an identical priority ranking, the first call received is queued ahead of the later call received 610.

The system in this example is able to maintain four calls being serviced by operators and four calls waiting in the queue in order of their priority indicator. At this point, all eight lines from the telecommunication provider to the Taxi Service Provider's internal telephone system are occupied and no further calls can be received by the phone system to have their priority indicator calculated and their position in the queue determined.

In a preferred embodiment there is at least one incoming line from the telecommunication provider to the Taxi Service Provider's internal telephone system which is reserved for processing incoming calls. In this embodiment, if there were eight incoming lines and four operators, the maximum number of calls that could be held in the queue would be three. Therefore, there would be the eighth line available for another incoming call to be received, its priority indicator calculated and its position in the queue determined. If the priority indicator was lower than all other calls waiting in the queue, the call would be off loaded 611. However, if its priority indicator was higher than the priority indicator of at least the lowest call in the queue, the incoming call would be inserted into the queue and the lowest call in the queue dropped. In this way calls can still be received by the taxi service provider and the highest priority calls inserted into the queue.

In a preferred embodiment the prioritization and queuing of incoming communications takes place within the telecommunication provider's system. In this embodiment, the records of the priority indicators are held by the user of the system but can be accessed by the telecommunication provider. As each incoming communication is received by the telecommunication provider, the telecommunication provider calculates the priority indicator and places the communication in an ordered queue of incoming communications. As each line to the user of the system becomes free, the highest priority call is passed to the user of the system. The advantage of this embodiment is that all calls can have their priority indicator calculated and be queued. It eliminates the disadvantage of an incoming communication having to secure an available incoming line to the user of the system before they can have their communication placed in a queue. This will ensure that the only calls passed to the user of the system are those which are most highly valued.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A system for prioritising incoming communications including:
a. a processor for identifying the origin of each of at least some of the incoming communications by an origin identifier;
b. a processor for associating a fixed priority indicator with each origin identifier in a set of origin identifiers such that each priority indicator is unique within said set; and
c. a processor for placing each incoming communication into an ordered queue on the basis of its associated priority indicator.

2. A system as claimed in claim 1 wherein at least one of the fixed priority indicators is set by a user of the system.

3. A system as claimed in claim 2 wherein at least one of the fixed priority indicators is permanent.

4. A system as claimed in claim 3 wherein at least some of the origin identifiers are not members of said set and wherein each of these origin identifiers are associated with a dynamic priority indicator.

5. A system as claimed in claim 4 wherein all of the priority indicators can be unique.

6. A system as claimed in claim 5 wherein the priority indicator of an origin identifier is representative of the degree to which the origin identified by the origin identifier meets one or more criteria.

7. A system as claimed in claim 6 wherein the criteria include an economic value of the incoming communication from the origin identified by the origin identifier.

8. A system as claimed in claim 7 wherein the criteria include a value related to the number of communications associated with the origin identifier.

9. A system as claimed in claim 7 wherein at least one of the criteria relates to the time of the incoming communication.

10. A system as claimed in claim 7 wherein each incoming communication is an incoming telephone call.

11. A system as claimed in claim 10 wherein each origin identifier is a Caller Identification Number of a telephone call.

12. A system as claimed in claim 10 wherein at least one channel by which incoming communications can be received is reserved for the receipt of an incoming communication.

13. A method of associating a dynamic priority indicator to an origin identifier of an incoming communication including the steps of:
a) identifying the origin identifier of the incoming communication;
b) prioritising the incoming communication;
c) calculating a priority indicator for the origin identifier; and
d) recording the priority indicator.

14. A method of associating a dynamic priority indicator to an origin identifier of an incoming communication including the steps of:
a) identifying the origin identifier of the incoming communication;
b) prioritising the incoming communication;
c) calculating a priority indicator for the origin identifier; and
d) recording the priority indicator wherein the step of prioritising the incoming communication is performed according to the method in claim 27.

15. A method as claimed in claim 14 wherein the origin identifier is associated with a pre-existing priority indicator.

16. A method as claimed in claim 15 wherein the step of calculating a priority indicator for the origin identifier of the incoming communication may include a calculation related to a pre-existing priority indicator associated with the origin identifier.

17. A method as claimed in claim 16 wherein the step of calculating a priority indicator for the origin identifier of the incoming communication includes associating the origin identifier with a default priority indicator.

18. A method as claimed in claim 17 wherein the step of calculating a priority indicator for the origin identifier occurs without manual intervention.

19. A method as claimed in claim 18 wherein the step of calculating a priority indicator for the origin identifier includes reference to the number of incoming communications with a related origin identifier during a period of time.

20. A method as claimed in claim 19 wherein the step of calculating a priority indicator for the origin identifier includes a calculation related to each historic priority indicator associated with the origin identifier during a period of time.

21. A method as claimed in claim 20 wherein the period of time is specified by a user.

22. A method as claimed in claim 21 wherein no reference is made to incoming communications received earlier than the start of the specified period of time when calculating the priority indicator.

23. A method of prioritising incoming communications associated with origin identifier including the steps of:
a) determining a priority indicator of the origin identifier of an incoming communication; and
b) inserting the incoming communication into an ordered queue containing other incoming communications with associated priority indicators wherein the queue is ordered on the basis of the priority indicators;
wherein for a set of the origin identifiers each origin identifier is associated with a fixed priority indicator and each priority indicator is unique within said set.

24. A method of prioritising incoming communications associated with origin identifier including the steps of:
a) determining a priority indicator of the origin identifier of an incoming communication; and
b) inserting the incoming communication into an ordered queue containing other incoming communications with associated priority indicators wherein the queue is ordered on the basis of the priority indicators;
wherein for a set of the origin identifiers each origin identifier is associated with a fixed priority indicator and each priority indicator is unique within said set wherein the method is performed outside the communication system of a user of the system claimed in claim 1.

25. Apparatus for prioritising incoming communications associated with origin identifiers, including:
a) a processor arranged for receiving notification of an incoming communication, determining an origin identifier associated with the incoming communication, retrieving a priority indicator associated with the origin identifier from a memory, placing the incoming communication into an ordered queue containing other incoming communications with associated priority identifiers on the basis of the priority indicator, and identifying a communication at the top of the queue for further processing; and
b) a memory arranged for storing priority indicators; wherein for a set of the origin identifiers each origin identifier is associated with a fixed priority indicator and each priority indicator is unique within said set.

26. An apparatus as claimed in claim 25 wherein said memory is further arranged for starting an order description associated with the origin identifier.

27. An apparatus as claimed in claim 26 wherein said memory is further arranged for storing an address associated with the origin identifier.

28. An apparatus as claimed in claim 27 wherein said memory is further arranged for storing other information associated with the origin identifier.

29. An apparatus as claimed in claim 28 wherein said memory is further arranged for storing a reason for the association of the priority indicator with the origin identifier.

30. Computer executable instructions arranged to perform the steps of claim 23.

31. Computer software for prioritising incoming communications, including:
(a) a module arranged for determining notification of an incoming communication, retrieving an origin identifier associated with the incoming communication, retrieving a priority indicator associated with the origin identifier from a database, placing the incoming communication into an ordered queue containing other incoming communications with associated priority identifiers on the basis of the priority indicator, and identifying a communication at the top of the queue for processing; and
(b) a database arranged for storing priority indicators; wherein for a set of the origin identifiers each origin identifier is associated with a fixed priority indicator and each priority indicator is unique within said set.

32. Storage media arranged for storing the software claimed in claim 31.

33. Electronic signals resulting from the execution of the software as claimed in claim 31.

34. Electronic signals resulting from the operation of the apparatus as claimed in claim 25.

35. A system for prioritising communications including:
(a) a telecommunication service provider adapted to receive communications identify the origin or at least some of the communications by an origin identifier, associate a priority indicator with each origin identifier, and place at least some of the incoming communications into an ordered queue on the basis of their associated priority indicators; and
(b) a communication receiver adapted to receive communications from the telecommunication service provider.

36. A system as claimed in claim 35 wherein there are a fixed number of communication channels between the telecommunication service provider and the communication receiver through which the communication receiver can receive communications from the telecommunication service provider.

37. A system as claimed in claim 36 wherein communications are received by the communication receiver in an order dependent on the order of the communications in the ordered queue.

38. A system as claimed in claim 37 wherein for a set of origin identifiers, each origin identifier in the set is associated with a fixed priority indicator such that each fixed priority indicator is unique.

39. A system as claimed in claim 38 wherein at least one of the fixed priority indicators is permanent.

40. A system as claimed in claim 39 wherein at least some origin identifiers are not members of said set and wherein each of these origin identifiers is associated with a dynamic priority indicator.

41. A system as claimed in claim 40 wherein all of the priority indicators are unique.

42. A system as claimed in claim 41 wherein the telecommunication service provider is a telephone service provider.
